(19) United States
(12) Patent Application Publication
(10) Pub. No.: US 2011/0186252 A1
(43) Pub. Date: Aug. 4, 2011

(54) ENGINEERED COMPOSITE PRODUCT AND METHOD OF MAKING THE SAME

(75) Inventors: Ramjee Subramanian, Espoo (FI); Hannu Paulapuro, Vantaa (FI)

(73) Assignee: UPM-KYMMENE CORPORATION, Helsinki (FI)

(21) Appl. No.: 13/057,446

(22) PCT Filed: Aug. 3, 2009
(86) PCT No.: PCT/FI2009/050644

§ 371 Date: Apr. 22, 2011

(30) Foreign Application Priority Data
Aug. 4, 2008 (FI) 20085760

(51) Int. Cl. D21H 27/38; D21H 11/02; D21H 27/00; B82Y 30/00

(52) U.S. Cl. 162/128; 162/149; 162/138; 977/742

(57) ABSTRACT

In an engineered composite product containing cellulose fibres, cellulosic fibrillar fines and pigment, the main component of the composite product is pigment with a percentage of 40-80% by weight, the percentage of cellulosic fibrillar fines is 15-40% by weight, and the percentage of cellulose fibres is 5-30% by weight. Method of making the engineered composite product comprises the steps of combining said components in an aqueous solution and preparing the composite product by de-watering the aqueous solution. The components are combined in the aqueous solution in such proportion that the percentage of pigment in the final composite product is 40-80% by weight, the percentage of cellulosic fibrillar fines is 15-40% by weight, and the percentage of cellulose fibres is 5-30% by weight.

The present invention relates to an engineered composite product containing cellulose fibres, cellulosic fibrillar fines and pigments.

The invention also relates to a method of making an engineered composite product.

Several million tons of uncoated woodfree fine papers are produced and consumed every year as printing and writing papers, such as copy papers. Fine papers are typically produced from chemical pulp fibres and pigments which are used as fillers. Basically, fine paper is a composite material consisting of cellulose fibres as the backbone that brings the sheet strength and rigidity, and filler, which in combination with fibres contributes to the light scattering and the pore size of paper. The predominant filler is CaCO₃, most frequently PCC (precipitated calcium carbonate), which has a growing market share. The commercial success of PCC relates to the high bulk that PCC provides and the economic solution of on-line production.

Pigments are an integral component of uncoated woodfree fine papers intended for printing and writing. Most often fillers are inorganic minerals with a particle size in the range of 0.1 μm to 10 μm. Different types of pigments are used in papermaking, depending on the process conditions, the cost-effectiveness of using pigment, and paper quality requirements. Pigments are added to paper furnish to reduce the cost of papermaking, to promote the dewatering of the wet sheet, and to improve the optical properties and printability of paper. On the other hand, pigments impair the strength and stiffness of paper, which is why the proportion of pigments in conventional fine paper is limited to 20-25% by weight of dry paper. Increasing the pigment content impairs the strength of paper by decreasing the relative share of fibres and by reduced inter-fibre bonding. Thus, in conventional fine paper, light scattering and strength are inversely related.

Filler is also used for replacing expensive fibres. The cost savings on raw materials is clear, with PCC prices typically only 20% of pulp market prices, but the filler level is limited by the reduction of mechanical properties caused by increased filler level. Increased filler content significantly limits the tensile strength and stiffness of paper, and it also contributes to dusting. High filler level may decrease runnability as a result of reduced wet strength. Typically, the limiting facfor increasing the filler content in fine paper is either stiffness, dusting or wet strength, while tensile and tear strength are normally sufficient for most applications.

Recent research initiatives in the field of conventional papermaking have been designed to eliminate this bottleneck, i.e. to increase the strength and light scattering of conventional paper and to increase the percentage of pigment in paper. For instance, attempts have been made to develop new fillers that allow increased filler level in the paper. Composite co-structured or co-absorbed pigments containing binders have been claimed to allow higher filler levels in paper.

U.S. Pat. No. 4,445,970 discloses a composite fine paper containing 30-70% mineral filler. The paper is produced from a furnish containing large quantities of filler and 3-7% of an ionic latex which is selected to provide good retention and good strength.

WO 2006120235 discloses a paper product comprising 15-70% by weight of fillers. In the production process, polymers are added to a furnish comprising fillers and fibres in at least three steps.

U.S. Pat. No. 5,731,080 discloses a fibre-based composite material comprised of a plurality of fibres of expanded specific surface area and hydrophilic character, having microfibrils on their surface, and crystals of precipitated calcium carbonate organized essentially in clusters of granules directly grafted on to said microfibrils without binders or retention aids present at the interface between PCC and microfibrils, so that the majority of the crystals trap the microfibrils by reliable and non-labile mechanical bonding. The mineral component is told to be greater than 40% by weight, based on total solids of the composite material.

WO 02090652 discloses a fibre web in which 5-100% of the filler in the web is made up of cellulose fibrils or lignocellulose fibrils with light-scattering material particles deposited thereon. The coated cellulose fibrils constitute at maximum approximately 70% of the weight of the web. Anyway, the amount of mineral pigment in the paper is always less than 50% by weight.

U.S. Pat. No. 6,156,118 discloses a filler comprising noil produced from pulp fibres by refining and pigment mixed with the noil, the noil including noil fibres corresponding in size distribution to wire screen fraction P50 or finer. U.S. Pat. No. 6,251,222 discloses a method for producing filler, comprising the steps of refining and screening wood pulp to provide fractionated fibrils fraction that passes through a 100 mesh wire, and chemically precipitating calcium carbonate onto the surface of the fractionated fibrils fraction to provide a porous aggregate of calcium carbonate precipitated onto the surface of the fibrils. In each case, the amount of mineral pigment in paper is less than 50% by weight.

It is an object of the present invention to eliminate the disadvantages associated with the prior art.

It is another object of the invention to create a new product that can be made at low costs and used e.g. to replace conventional fine paper.

The engineered composite product according to the present invention is characterised by what is claimed in claim 1.

The method according to the present invention is characterised by what is claimed in claim 6.

The invention was conceived by applying a new model for the structure of paper. In conventional fine papers, cellulose fibres provide the structure of the paper. In the present invention, the structure, or bulk, of the paper is provided by pigment, such as PCC, and a minimal fraction of fibres. Using cellulosic fibrillar fines instead of cellulose fibres increases the strength effectiveness of the cellulose material. Cellulosic fibrillar fines are able to give higher bonding area and bond strength than fibres.

Thus, the invention may be considered a composition of matter: a composite sheet produced from a large proportion, typically over 50% by weight, of pigment, preferably a bulky mineral like PCC or synthetic silicates, bound together by fibrillar fines. A limited amount of long fibres (e.g. Abaca, synthetic or softwood pulp), typically 5-20% by weight, is added to improve the tear strength of the paper. A sheet like this has proven to have similar or improved mechanical properties compared to conventional uncoated fine papers and significantly improved optical properties. The raw material costs in total will be much lower than with conventional fine paper.

Accordingly, the main component of the new composite product is pigment with a percentage of 40-80% by weight, the percentage of cellulosic fibrillar fines is 15-40% by weight and the percentage of cellulose fibres is 5-30% by weight.

The new method comprises combining the components of the composite product in such proportion that the percentage of pigment in the final product is 40-80% by weight, the percentage of cellulosic fibrillar fines is 15-40% by weight and the percentage of cellulose fibres is 5-30% by weight.

Advantageously, the percentage of pigment is 45-65% by weight, preferably 50-60% by weight; the percentage of cellulosic fibrillar fines is 20-35% by weight, preferably 25-30% by weight; and the percentage of cellulose fibres is 5-20% by weight, preferably 10-15% by weight.

In addition to those three components, the engineered composite product may further contain small amounts of conventional papermaking chemicals, such as retention aid, size or starch.

Pigment used as the main component of the composite product may be selected from a group comprising precipitated calcium carbonate (PCC), ground calcium carbonate (GCC), clay, talc, titanium dioxide, silicates, organic pigment, and mixtures thereof. PCC is considered as one of the most favourable pigments.

Cellulose fibres, which are mainly used to reinforce the structure of the composite material, may be selected from a group comprising chemical, chemimechanical and mechanical pulp fibres made from softwood, hardwood or non-wood fibre material, synthetic fibres, and mixtures thereof.

Another advantage of producing the sheet from predominantly pigment and cellulosic fibrillar fines is that flocculation does not occur and sheet can consequently be formed at much higher solids, probably up to 20% solids. This could reduce water consumption in papermaking The high solids forming will also improve retention dramatically and remove, or at least decrease, the need for retention chemicals. A completely different wet-end and forming section could be designed because the volume, dewatering and rheology will be completely different from those of conventional paper production.

The invention is described below in greater detail with the help of some images and examples.

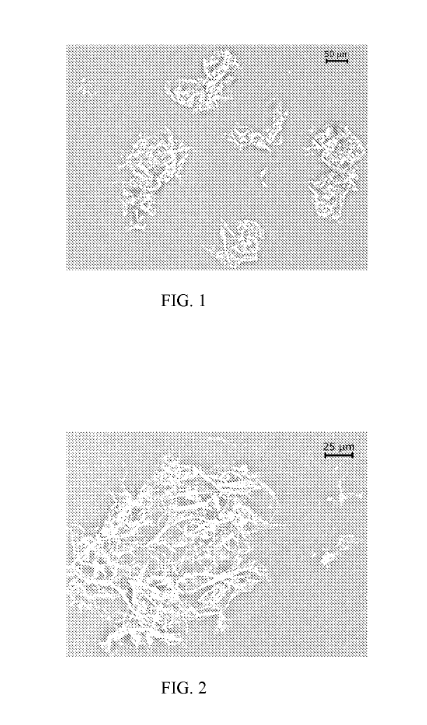

FIG. 1 is a negative phase contrast image of fibrillar fines obtained from bleached softwood kraft pulp.

FIG. 2 is a similar image with a higher magnification.

Cellulosic fibrillar fines, also referred to as secondary fines or microfibrillar cellulose, are fibre-derived particles that pass through a 75 μm diameter round hole or a 200-mesh screen of a fibre length classifier. Particles of this fraction are appreciably smaller than those of the standard fibre fractions, generally smaller than 200 μm. The smallest particles are of fibrillar nature and have widths in the range of 0.02-0.5 μm. It has been proven that cellulosic fibrillar fines enhance significantly the density and strength of paper. The contribution of fines on strength strongly depends on the source of fines. Refining more produces fibrillar fines from secondary cell wall (S₂ layer), which is more effective bonding agent than primary (P/S₁ layer) fines. Earlier studies have shown significant increase in the strength and bending stiffness properties of fine paper with the addition of cellulosic fibrillar fines to the stock suspension. Recently, it has been shown that fines improve retention of filler and tensile strength on addition of chemical pulp fines to a eucalyptus fibre-based fine paper furnish. On the other hand, light scattering may decrease due to addition of fines.

FIGS. 1 and 2 are images of cellulosic fibrillar fines obtained by microfibrillating bleached softwood kraft pulp. Each particle of fibrillar fines comprises a developed intertwined network. The fibrils are flexible and capable of holding water in the inter-fibrillar space of their network structure. According to the micrographs, the fibrils have high aspect ratios. On the other hand, the network nature makes it difficult to apply conventional particle size measurement for determining the particle size distribution for these fibrillar fines suspensions.

Cellulosic fibrillar fines may be produced from any fibrous organic raw material by different kinds of mechanical and/or chemical treatments. In addition to wood pulp and non-wood pulp, the fibrous raw material may comprise any organic vegetable material that consists of fibres. It is also possible to produce fibrillar fines by refining the cellulosic raw material and pigment together. The properties and behaviour of cellulosic fibrillar fines may be amended by chemical treatment, which may be carried out before, during or after the mechanical treatment, such as refining. It is also possible to precipitate the pigments on to the fibrils an/or fibres.

In the method according to the present invention, an aqueous solution is prepared by mixing pigment as the main component, cellulosic fibrillar fines that in the final product bind the pigment particles together, and cellulose fibres to reinforce the structure formed of pigment and cellulosic fibrillar fines. The new composite product may be produced e.g. in a conventional paper machine or in a modified paper machine. The consistency of the aqueous solution after mixing the components may be 0.5-20%, preferably 1-14%, most preferably 2-10%.

Using the new composition, sheets with as high as 60% by weight pigment content could be produced without apparent detrimental impact on mechanical properties, compared to handsheets produced from cellulose fibres and pigment. Stiffness of the new composite handsheets was similar to that of conventional copy papers or laboratory reference samples. As expected, light scattering and opacity far exceed conventional copy paper values, and formation is also superior.

Scanning electron microscope photographs of the surface of the new composite product showed that pigments are firmly attached to the network by cellulosic fibrillar fines. Fibrillar fines surround the pigment particles and form a network of pigment, fibrillar fines and pores. Typically, the pores have honeycomb-type of structure with varying void volume. Thus, it can be concluded that the new composite product has a continuous structure of fibrillar fines and pigments interspersed with fibres.

One interesting option is to produce a layered product that comprises at least one layer consisting essentially of cellulose fibres and at least one other layer consisting essentially of a network formed of pigment and cellulosic fibrillar fines. In a preferred mode, the composite product comprises a layer of cellulose fibres sandwiched between two layers formed of pigment and cellulosic fibrillar fines.

The paper-like composite product may be finished e.g. by calendaring, coating, sizing, or any other method used in connection with conventional papermaking.

In addition to a producing a composite product that is able to replace conventional fine paper, the new type of composite product can be produced for many other applications, such as for use as electronic printing paper. When preparing such a composite product, carbon nanotubes may be used separately or in combination with cellulosic fibrils and fibres and magnetic particles may be used as pigment.

### EXAMPLES 1-7

A suspension containing 90-95% cellulosic fibrillated fines was produced from non-dried ECF-bleached (elemental chlorine free) softwood pulp consisting of a mixture of pine and spruce in equal amounts, using Masuko supermass colloider. Masuko supermass colloider is a special type of grinder which enhances the external fibrillation of the fibres. In this device refining takes place between rotating and stationary stones with grits made of silicon carbide. The refining degree is increased by re-circulating the pulp suspension.

Long fibres used in the experiments consisted of fractionated softwood pulp fibres from a pine and spruce mixture, which was refined to 23° SR and fractionated using a 30-mesh screen.

Scalenohedral precipitated calcium carbonate (PCC) with a mean particle size of 2.4 μm was used as a pigment.

Reference handsheets were formed from a 70:30 mixture of hardwood and softwood pulp. Standard commercial copy paper, composed of 70% birch and 30% mixed softwood of pine and spruce, was used as another reference.

An experimental plan was designed to produce new composite handsheets containing a minimum of 50% of PCC, with a grammage of 80 g/m², as shown in Table 1. Fibrillar fines and pigment based handsheets were formed in a standard handsheet mould with a nylon fabric on top of the mesh in the sheet mould. No additives were added during the forming of high PCC content handsheets. Retention aid (250 g/t of C-PAM) was used in the forming of reference handsheets and long fibre and pigment based sheets. Pressing and drying were carried out according to standard methods. Table 1 shows the target compositions of the new composite samples.

TABLE 1

| | | Cellulosic | | |
|---|---|---|---|---|
| | | fibrillar | Unrefined eucalyptus | |
| Example | PCC % | fines % | fibres % | Long fibres % |
| 1 | 23 | 0 | 0 | 77 |
| 2 | 23 | 30 | 0 | 47 |
| 3 | 50 | 30 | 10 | 10 |
| 4 | 60 | 30 | 0 | 10 |

| | | |
|---|---|---|
| 5 | 23 | Reference - conventional laboratory sheets |
| 6 | 50 | Reference - conventional laboratory sheets |
| 7 | 23 | Commercial copy paper |

Dried handsheets were conditioned (23° C.; 50% RH). Relevant testing methods used in the analysis of handsheets are described in Table 2. In-plane tear strength was measured with MTS 400 tensile tester. PCC content was measured by ashing the sample at 525° C. in a muffle furnace.

TABLE 2

| Test Methods | Test Standards |
|---|---|
| Grammage | ISO 536 |
| Thickness and bulk density or apparent sheet density | ISO 534:1998 |
| Tensile strength by constant elongation method | ISO 1924-2:1994 |
| Bending stiffness | ISO 2493:1992 |
| Light Scattering | ISO 9416-1998 |
| Ash content | ISO 1762:2001(E) |

The properties measured from the handsheets are shown in Table 3. Examples 3 and 4 represent the new composite product comprising 50 or 60% PCC, 30% cellulosic fibrillar fines and 10% cellulose fibres. There is no immense difference between the thickness, bulk, stiffness or tensile index of the handsheets of examples 3 and 4 and those of example 5 (fibres and conventional percentage of PCC) or 2 (fibres, fibrillar fines and conventional percentage of PCC). On the other hand, the light scattering is significantly higher in examples 3 and 4 than in any other example.

TABLE 3

| | Composition | | | | | | Tensile | |
|---|---|---|---|---|---|---|---|---|
| | PCC - fibrils - | Grammage | PCC | Thickness | Bulk | Stiffness | index | Light scattering |
| Example | fibres | g/m2 | content % | μm | m³/t | mN m | kNm/kg | m²/kg |
| 1 | 23-0-77 | 87.8 | 24.9 | 164 | 1.87 | 0.29 | 17.45 | 55.42 |
| 2 | 23-30-47 | 86.9 | 24.8 | 130 | 1.49 | 0.39 | 41.77 | 80.28 |
| 3 | 50-30-10 | 84.9 | 49.7 | 140 | 1.65 | 0.31 | 29.00 | 169.9 |
| 4 | 60-30-10 | 82.1 | 60.5 | 139 | 1.70 | 0.21 | 21.44 | 175.4 |
| 5 | 23-0-77 | 89.2 | 24.9 | 141 | 1.64 | 0.26 | 25.77 | 70.94 |
| 6 | 50-0-50 | 86.9 | 50.8 | 138 | 1.71 | 0.11 | 7.85 | 107.5 |
| 7 | 23-0-77 | 79.2 | 22.9 | 96.1 | 1.21 | 0.27 | 44.70 | 56.35 |

The experiments show that high quality fine paper can be produced with a high percentage of pigment when a significant part of the cellulose pulp fibres is replaced with cellulosic fibrillar fines.

### EXAMPLES 8-15

A suspension containing cellulosic fibrillar fines was produced from non-dried ECF-bleached softwood pulp consisting of a mixture of pine and spruce in equal amounts, using the same ultra-fine friction grinder as in previous examples. 80% of the fibrillar fines used in the experiment consisted of particles that pass through a 37 μm hole or 400-mesh screen of a fibre length classifier.

Dried softwood pulp, made from 60% pine and 40% spruce, was refined to 23° SR and fractionated using a 30-mesh screen to obtain fractionated softwood fibres used as reinforcing fibres in these examples. Unrefined regenerated cellulose and unrefined eucalyptus fibres were also used as reinforcement fibres.

Conventional laboratory reference handsheets were formed from a 70:30 mixture of hardwood and softwood pulp. 250 g/t of C-PAM was used as retention aid when forming the reference handsheets.

Scalenohedral PCC with a mean particle size of 2.4 μm was used as the pigment in paper.

The test program is shown in Table 4. 80 g/m² handsheets with a minimum of 50% by weight PCC were produced. Eucalyptus, softwood pulp fibres and regenerated cellulose fibres were used as reinforcement to enhance the tear strength of the new composite material. In addition, 60 g/m² and 40 g/m² handsheets, reinforced with softwood pulp fibres, were produced.

Handsheets were formed in a standard handsheet mould with a nylon fabric on top of the mesh in the sheet mould. No extra water was added during forming and no additives were added. Dewatering time of the handsheets was 3-4 minutes. Pressing and drying were carried out according to standard methods.

Reference sheets were formed by standard method ISO 5269-1:2005 in the handsheet mould with the addition of retention aid.

TABLE 4

| | Fibrillar | Eucalyptus | Other | | PCC | Thickness |
|---|---|---|---|---|---|---|
| Example | fines % | fibres % | fibres % | Grammage g/m² | content % | μm |
| 8 | 15 | 30 | 0 | 85.1 | 53.4 | 151 |
| 9 | 30 | 15 | 0 | 84.7 | 53.9 | 142 |
| 10 | 30 | 10 | 10 (sw) | 84.9 | 49.7 | 140 |
| 11 | 30 | 10 | 10 (sw) | 63.3 | 51.7 | 109 |
| 12 | 30 | 10 | 10 (sw) | 41.3 | 51.3 | 74 |
| 13 | 30 | 5 | 10 (RC) | 84.8 | 52.8 | 153 |
| 14 | 30 | 0 | 10 (sw) | 82.1 | 60.6 | 139 |

| | | | | |
|---|---|---|---|---|
| 15 | Reference 70:30 hw/sw | 81.0 | 50.8 | 138 |

Note:
sw—softwood,
hw—hardwood,
RC—regenerated cellulose

Dried handsheets were conditioned (23° C., 50% RH). Relevant testing methods used in the experiment are shown in Table 5. Measurements were made with a minimum of six test specimens for each example. In-plane tear strength was measured with MTS 400 tensile tester according to the procedure described in Tappi J. 83 (2000), 4, p. 83-88.

TABLE 5

| Test Method | Test Standard |
|---|---|
| Grammage | ISO 536 |
| Thickness and bulk density or apparent sheet density | ISO 534:1998 |
| Air permeance | ISO 5636-3:1992 |
| Tensile strength - Constant elongation method | ISO 1924-2:1994 |
| Internal bond strength | T 569 pm-00 |
| Fracture toughness and In-plane tear strength | Scan-P 77:95 |
| Bending stiffness | ISO 2493:1992 |
| Brightness | ISO 2470:1999 |
| Light Scattering | ISO 9416-1998 |
| Ash content | ISO 1762:2001(E) |

The grammage, PCC content and thickness of the handsheets are shown in Table 4. At the same basis weight, the new composite sheets and the reference samples had about the same thickness. On the other hand, decreasing grammage significantly reduced the thickness of the new composite sheets.

Other properties of the handsheets at various PCC contents are compared in Tables 6 and 7. The bulk of the new composite samples is comparable to that of handsheets formed from conventional reference furnish.

At the same grammage, bending stiffness of the new composite samples made from fibrillar fines and filler based furnish (examples 8-10, 13 and 14) is higher than that of the reference handsheets lacking fibrillar fines (example 15). Reduction of the proportion of fibrillar fines from 30% to 15% in the new composite product contributes to lowering its bending stiffness (examples 9 and 8). Comparing examples 10, 11 and 12, the bending stiffness of the new composite product significantly deteriorates when the handsheet grammage decreases from 80 g/m² to 40 g/m².

TABLE 6

| | | | | | | Internal |
|---|---|---|---|---|---|---|
| | Fines - | | Bending | Perme- | Tensile | bond |
| | eucalyptus - | Bulk | stiffness | ability | index | strength |
| Example | other fibres | m³/t | m/Nm | μm/Pas | kNm/kg | J/m² |
| 8 | 15-30-0 | 1.77 | 0.19 | 1.3 | 16.3 | 364 |
| 9 | 30-15-0 | 1.68 | 0.28 | 0.2 | 28.3 | 789 |
| 10 | 30-10-10 (sw) | 1.80 | 0.33 | 0.3 | 29.0 | 873 |
| 11 | 30-10-10 (sw) | 1.71 | 0.15 | 0.3 | 32.2 | 646 |
| 12 | 30-10-10 (sw) | 1.79 | 0.04 | 0.5 | 27.1 | 449 |
| 13 | 30-5-10 (RC) | 1.71 | 0.21 | 0.6 | 21.4 | 559 |
| 14 | 30-0-10 (sw) | 1.70 | 0.35 | 0.2 | 27.0 | 470 |
| 15 | Reference | 1.71 | 0.11 | 25 | 7.80 | 220 |
| | 70:30 | | | | | |

The permeability of handsheets as a function of pigment content is also shown in Table 6. Reference handsheets (example 15), which are composed of open network structure of fibres and filler, show the highest permeability. Handsheets composed of fibrillar fines and pigment network (examples 8-14) show very low air permeability. Permeability of the new composite handsheets is significantly lower than that of fibre-based sheets. This is due to the tortuous path and closed pores in the network structure, suggesting that fibrillar fines are also intimately bonded with the matrix blocking connectivity of the pore structure.

Tensile index and internal bond strength of the new composite material and the reference sheets is shown in Table 7. The new composite handsheets (examples 8-14) exhibit significantly higher tensile index and z-directional bond strength than the fibre-based reference sheets (example 15). Among the new composite samples, reduction of fibrillar fines content and reinforcement with regenerated cellulose fibres seem to deteriorate the bonding strength of fine paper.

TABLE 7

| | | | In-plane | | |
|---|---|---|---|---|---|
| | Fines - | Fracture | tear | ISO | Light |
| | eucalyptus - | toughness | index | brightness | scattering |
| Example | other fibres | mJm/g | Jm/mg | % | m²/kg |
| 8 | 15-30-0 | 1.90 | 2.45 | 92.3 | 145 |
| 9 | 30-15-0 | 2.05 | 3.24 | 91.6 | 171 |
| 10 | 30-10-10 (sw) | 5.98 | 6.85 | 90.8 | 162 |
| 11 | 30-10-10 (sw) | 4.39 | 6.69 | 91.1 | 162 |
| 12 | 30-10-10 (sw) | 4.02 | 6.19 | 90.8 | 157 |
| 13 | 30-5-10 (RC) | 4.89 | 5.04 | 91.7 | 164 |
| 14 | 30-0-10 (sw) | 4.2 | 5.60 | 92.5 | 175 |
| 15 | Reference | 1.26 | 2.07 | 88.3 | 108 |
| | 70:30 | | | | |

In-plane tear index and fracture toughness are higher for new composite samples compared to conventional fibre-based reference sheets, as shown in Table 7. The ability to avoid fracture at flaw decreases when the amount of fibrillar fines is lowered in the new composite handsheets from 30% to 15%. At a grammage of 80 g/m², the reinforcing ability of the fibres in the new composite handsheets decreases in the following order: softwood>regenerated cellulose>eucalyptus fibres.

The new composite handsheets show significantly higher tensile strength compared to fibre-based reference handsheets. This is due to enhanced modulus of microfines particle network, inter-micro fines bond strength and relative bonded area. Reinforcing with regenerated cellulose fibres reduces the tensile strength of the new composite handsheets due to the lower modulus and conformability of those fibres. On the other hand, softwood long fibre reinforcement enhances tensile strength due to improved bonding and activation of the fibres in network. By activation, originally kinky, curly or otherwise deformed fibre segments unable to carry load in a network are modified into active load bearing components of the network.

The fracture toughness of a composite material is a function of fibre length, bond density, fibre strength and bonding strength. In a fibrillar fines and pigment network, higher modulus of fibrillar fines particle network, enhanced bonded area and inter-fibrillar fines bond strength contribute towards its higher fracture toughness in contrast to fibre-based network. However, fracture resistance of the new composite handsheets depends significantly on the characteristics of the fibres used in the furnish and the amount of fibrillar fines fraction in the network. Bonding and conformable long fibres, like softwood, as well as higher fibrillar fines proportion contribute towards improving the flaw rupture resisting ability of the new composite material.

Table 7 also demonstrates that light scattering and brightness, which increase already at high filler content in a conventional fine paper, are even higher with the new composite material. Reduction of fibrillar fines proportion in the new composite handsheets contributes negatively to the light scattering. The significant improvement of the brightness and light scattering of the new composite handsheets results from the increased number of optically active micropores. Form ation of micropores could be confirmed by scanning electron microscopic studies. It seems that during consolidation process, shrinking of fibril network is restrained, leading to the creation of large number of micropores, apparently of light-scattering size. Reducing the amount of fibrillar fines in the new composite handsheets deteriorates the light scattering of paper. Thus, we find that the fraction of fibrillar fines is crucial in augmenting the light scattering ability of the composite handsheets.

The invention is not intended to be limited to the examples described above but it is possible to make various modifications thereto without departing from the scope of the invention defined in the following claims.

1.-19. (canceled)

20. Engineered fine paper containing cellulose fibres, cellulosic fibrillar fines and pigment, characterised in that the main component of the fine paper is pigment with a percentage of 50-60% by weight, the percentage of cellulosic fibrillar fines is 25-30% by weight, and the percentage of cellulose fibres is 10-15% by weight.

21. Fine paper according to claim 20, characterised in that the pigment is selected from a group comprising precipitated calcium carbonate, ground calcium carbonate, clay, talc, titanium dioxide, silicates, organic pigment, and mixtures thereof.

22. Fine paper according to claim 20 or 21, characterised in that the cellulose fibres are selected from a group comprising chemical, chemimechanical and mechanical pulp fibres made from softwood, hardwood or non-wood fibre material, synthetic fibres, and mixtures thereof.

23. Fine paper according to claim 20, characterised in that it further comprises a small amount of at least one conventional papermaking chemical, such as retention aid, size or starch.

24. Method of making an engineered fine paper containing cellulose fibres, cellulosic fibrillar fines and pigment, comprising the steps of combining said components in an aqueous solution and preparing the fine paper by dewatering the aqueous solution, characterised by combining said components in the aqueous solution in such proportion that the percentage of pigment in the final product is 50-60% by weight, the percentage of cellulosic fibrillar fines is 25-30% by weight, and the percentage of cellulose fibres is 10-15% by weight.

25. Method according to claim 24, characterized by selecting pigment from a group comprising precipitated calcium carbonate, ground calcium carbonate, clay, talc, titanium dioxide, silicates, organic pigment, and mixtures thereof.

26. Method according claim 24 or 25, characterised by selecting cellulose fibres from a group comprising chemical, chemimechanical and mechanical pulp fibres made from softwood, hardwood or non-wood fibre material, synthetic fibres, and mixtures thereof.

27. Method according to claim 24, characterized by using cellulosic fibrillar fines comprising fibre-derived particles that are able to pass through a 75 μm diameter round hole or a 200-mesh screen of a fibre length classifier.

28. Method according to claim 24, characterised by producing cellulosic fibrillar fines by mechanical treatment of cellulosic fibre material, such as wood pulp, non-wood pulp, or vegetable material.

29. Method according to claim 28, characterised by treating the cellulosic fibrillar fines with chemicals before, during or after said mechanical treatment.

30. Method according to claim 28, characterised by producing cellulosic fibrillar fines by mechanical treatment of cellulosic fibre material and pigment as a mixture.

31. Method according to claim 24, characterised by preparing an aqueous solution with a consistency of 0.5-20%, preferably 1-14%, most preferably 2-10%, and dewatering the aqueous solution in a conventional or a modified paper or board machine.

32. Method according to claim 24, characterised by adding a small amount of at least one conventional papermaking chemical, such as retention aid, size or starch, to the aqueous solution.

33. Method according to any one of claim 24 or 32, characterised by finishing the fine paper by calendering, coating, sizing, or any other similar treatment.

34. Method according to claim 24, characterised by producing fine paper with a grammage of 40 to 220 g/m² and with properties allowing its use as printing or writing paper.

35. Method according to claim 24, characterised by producing a layered product comprising at least one layer consisting essentially of cellulose fibres and at least one layer consisting essentially of a network formed by pigment and cellulosic fibrillar fines.

36. Method according to claim 24, characterised by producing electronic printing paper from a mixture of cellulosic fibrillar fines, carbon nanotubes either alone or in combination with cellulose fibres, and magnetic particles.
